(19) United States
(12) Patent Application Publication
(10) Pub. No.: US 2019/0018453 A1
(43) Pub. Date: Jan. 17, 2019

(54) ACCESSORY MONITOR FOR PORTABLE COMPUTING DEVICES

(71) Applicant: Jordan Rhodes, Neenah, WI (US)

(72) Inventor: Jordan Rhodes, Neenah, WI (US)

(21) Appl. No.: 15/647,584

(22) Filed: Jul. 12, 2017

(51) Int. Cl. G06F 1/16

(52) U.S. Cl. CPC G06F 1/1647; G06F 1/1616; G06F 1/1681; G06F 1/1654

(57) ABSTRACT

An accessory monitor is described to attach and detach to a portable computing device.

### CROSS-REFERENCE TO RELATED APPLICATIONS

The present invention claims priority to Provisional Application Ser. No. 62/362,181 filed on 14 Jul. 2016

### FIELD OF THE INVENTION

The present invention relates generally to the field of accessory monitors, and more particularly to monitors that are portable and easily attached to portable computing devices.

### BACKGROUND OF THE INVENTION

Use of multiple computer monitors can increase productivity and efficiency. However, when using a laptop on the go, there is no convenient way to bring a second monitor with you. It is not practical to carry a large and heavy monitor everywhere. This makes it difficult to be productive and efficient when working in coffee shops, libraries, plane rides and virtually all locations outside of your office. The present invention solves the problem of not having a second monitor when on the go.

### SUMMARY

In one embodiment the present invention comprises an accessory monitor assembly, comprising: a frame comprised of a front retainer and a rear retainer, wherein the rear retainer and the front retainer define a space therebetween; a first arm and a second arm coupled to the frame, wherein the first arm is mounted to a first side of the rear retainer, wherein the second arm is mounted to a second side of the rear retainer, wherein the first arm and second arm are configured to extendingly couple and de-couple the accessory monitor assembly to a portable computer device; and a monitor comprised of a flat display coupled to the frame, wherein the monitor is configured to be stored in the space via rotation of the monitor into the space about a fixed axis, and wherein the monitor is configured to be removed from the space via rotation of the monitor out of the space about the fixed axis. In one embodiment, the fixed axis comprises two fixed axes, and wherein the monitor comprises two posts, and wherein the two posts are disposed about the two fixed axes. In one embodiment, the frame comprises two recesses, wherein the two recesses are configured to receive and release the two posts. In one embodiment, the two recesses are each defined by curved walls. In one embodiment, the monitor is configured to be received and released from the frame via linear movement of at least one of the two posts into or from at least one of the two recesses. In one embodiment, the monitor is configured to be received and released from the frame via linear movement of both of the two posts into or from the two recesses. In one embodiment, each recess is comprised of a stopper configured to retain one of the two posts during the rotation of the monitor. In one embodiment, the stopper is spring loaded. In one embodiment, the flat display is configured to be viewable in conjunction with a display of the portable computer device when only one of the two posts is received within one of the two recesses. In one embodiment, the two posts are orthogonal to a surface of the flat display, wherein the monitor comprises two opposite ends and a top and a bottom, and wherein each of the two posts are disposed centrally between the top and bottom along the two opposite ends. In one embodiment, each of the two opposite ends is coupled to the flat display via a mechanism that allows the display to pivot forward or backward with respect to the frame. In one embodiment, the mechanism comprises a hinge.

In one embodiment, the present invention comprises an accessory monitor assembly for use with a portable computer device comprising: an attachment mechanism configured to releasably attach the assembly to portable computer devices, wherein the attachment mechanism is also configured to de-attach the assembly from the portable computer devices; and a monitor comprised of a flat display, wherein the monitor is coupled to the attachment mechanism, wherein the monitor is configured to be pivotally rotated either to the left or right with respect to the assembly via a first rotation mechanism and along an axis that is orthogonal with respect to a surface of the flat display. In one embodiment, the monitor comprises two opposite ends and a top and a bottom, wherein the first rotation mechanism is disposed between the top and bottom along and between one of the two opposite ends. In one embodiment, the assembly comprises a second rotation mechanism, wherein the second rotation mechanism is configured to mate with the first rotation mechanism. In one embodiment, the first rotation mechanism comprises a post that is disposed about the axis. In one embodiment, the monitor is configured to be attached to and decoupled from the attachment mechanism via the first rotation mechanism. In one embodiment, the portable computer device is a laptop or notebook computer.

In one embodiment the present invention comprises a method of attaching an accessory monitor to a portable computer for use with the portable computer, comprising the steps of: attaching the accessory monitor to a back side of a portable computer having a display; rotating the accessory monitor either to the left or to the right with respect a center of the display to view the accessory monitor and the display; rotating the accessory monitor either to the right or to the left with respect to the center of the display to store the accessory monitor; and removing the accessory monitor from the back side of the portable computer when needed to reduce weight of the portable computer for transport, for use with another computer device, for convenience, or when it is no longer needed. In one embodiment, the monitor comprises a flat screen and two opposite ends and a top and a bottom, wherein the step of rotating is performed about an axis that is orthogonal to the flat screen, and wherein the axis is located between the top and bottom along and between the two opposite ends.

### BRIEF DESCRIPTION OF THE DRAWINGS

Various embodiments of the invention are disclosed in the following detailed description and accompanying drawings.

FIG. 1 illustrates a front perspective view of a portable monitor and a computing device, in accordance with one embodiment of the present invention;

FIG. 2 illustrates a front perspective view of the portable monitor in an open position, in accordance with one embodiment of the present invention;

FIG. 3 illustrates a front perspective view of the portable monitor aligned with the computing device, in accordance with one embodiment of the present invention;

FIG. 4 illustrates a front perspective view of the portable monitor locked on to the computing device, in accordance with one embodiment of the present invention;

FIG. 5 illustrates a rear perspective view of the portable monitor, in accordance with one embodiment of the present invention;

FIG. 6 illustrates a perspective view of the portable monitor rotating during use, in accordance with one embodiment of the present invention;

FIG. 7 illustrates a perspective view of the portable monitor in use from the rear, in accordance with one embodiment of the present invention;

FIG. 8 illustrates a perspective view of the portable monitor in use from the front, in accordance with one embodiment of the present invention;

FIG. 9 illustrates a stopper, in accordance with one embodiment of the present invention; and

FIG. 10 illustrates a cut away detailed view of hinge used with a monitor, in accordance with one embodiment of the present invention.

### DETAILED DESCRIPTION AND PREFERRED EMBODIMENT

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

Throughout the course of discussion that follows, certain terms are used throughout such as “top”, “bottom”, “upper”, “lower”, “side”, “front”, “rear” and the like. These terms provide a suitable frame of reference with regard to the accompanying drawings, but are not intended to overly limit of the inventive concepts that are described herein, except where specifically and notably indicated.

The presently described invention generally relates to a monitor that can attach and detach to a portable monitor, and flip, pivot, or rotate to either side of the computing device.

In addition, the drawings presented herein are intended to adequately illustrate the salient features of the system, including the portable monitor elements. To that end, it should be understood that the drawings may not be necessarily to scale and no reliance on scaling of the same should be made other than to provide a required understanding of features.

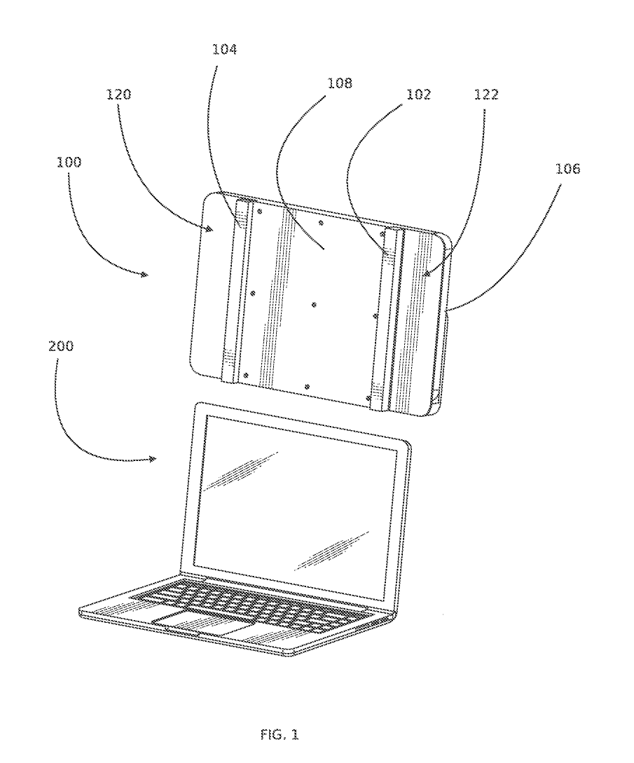

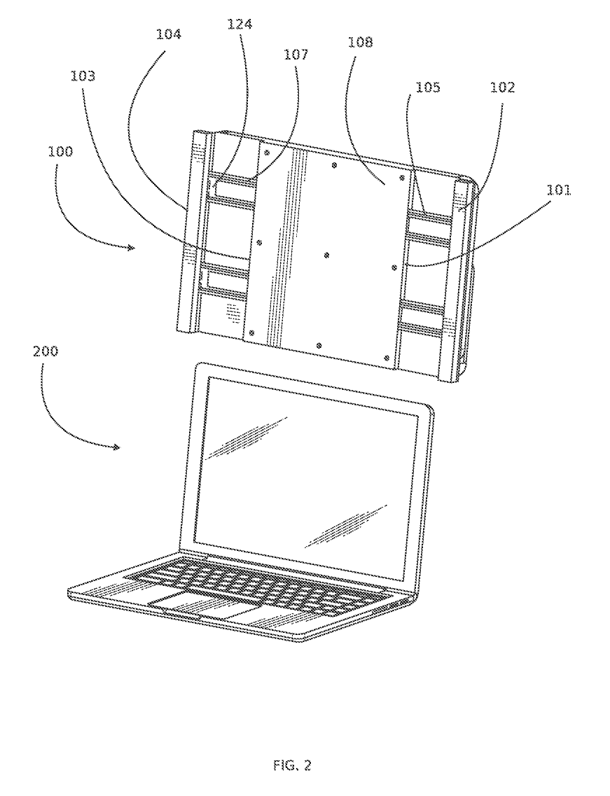

FIG. 1 and FIG. 2 depicts an exemplary monitor assembly 100 relative to a portable computing device 200. The monitor assembly 100 is shown having approximately the same height and length as the portable computing device 200. The monitor assembly 100 has a first arm 102 and a second arm 104, which are used to secure the monitor assembly 100 to the portable computing device 200.

In an embodiment, the first arm 102 may be positioned on a first side 120 of the monitor assembly 100. Similarly, the second arm may be positioned on a second side 122 of the monitor assembly 100 to provide at least two extendible positions, an open position and a closed position. FIG. 1 illustrates each arm 102, 104 in a closed position with each arm is disengaged from device 200.

FIG. 2 depicts the monitor assembly 100 with arms 102 and 104 in an open position. In the shown embodiment, arms 102 and 104 extend a predetermined distance to adequately secure the monitor assembly 100 to the portable computing device 200. In an embodiment, each arm 102, 104 is extendably mounted to a housing 108 by one or more members 105. During use, the user may apply lateral force to each arm to extend distally from the housing, or retract each arm to engage with device 200. In an embodiment, monitor assembly 100 is frictionally engaged with the computing device 200. This is made possible by the user extending and retracting each member 105 to frictionally engage the arms 102,104 with the perimeter of the device 200 until a suitable pressure is applied to create frictional force to retain the portable monitor in position.

In further embodiments, each member may be telescoping, mechanically or pneumatically extendable, foldably extendable, among other forms of extendability known in the art.

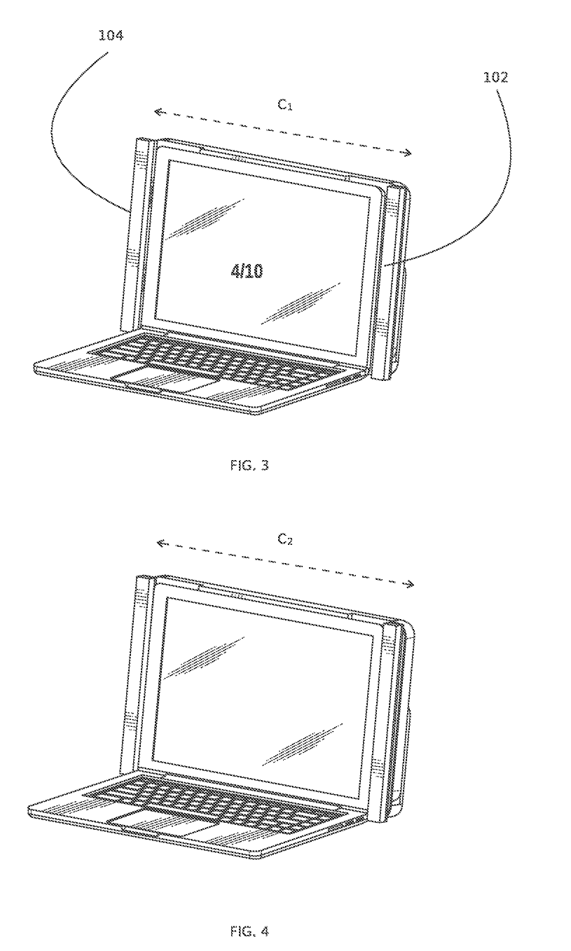

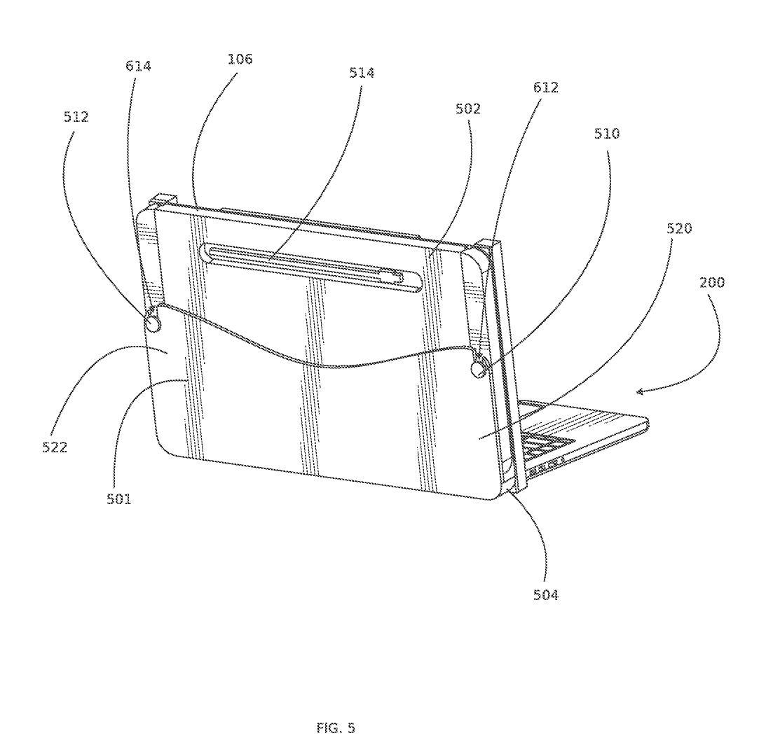

FIG. 3 depicts the monitor assembly 100 placed behind a portable computing device 200 with arms 102 and 104 in the open position, while FIG. 4 illustrates the arms in the closed position.

In a preferred embodiment, a user laterally extends each arm to open position C₁ such that each arm is laterally extended past the perimeter of the device 200. A user may then apply medial pressure to the arms to retract to the closed and in use position C₂, until the arms frictionally engage with the device 200, thus retaining the monitor assembly 100 in place during use.

In an embodiment, each arm 102, 104 is extended to position C₂, until the arm engages with the outer edge of the device 200. Each arm 102, 104 may be suitably dimensioned to remain outside the perimeter of the display area 202 of the device 200 such that a user's view is not obstructed while the monitor assembly 100 is engaged.

In one embodiment, the arms 102 and 104 are spring loaded to bias arms 102 and 104 to remain in place on device 200.

In a different embodiment, it is contemplated that monitor assembly 100 can be configured such that its arms up and down rather than to the left and right to grip a computer device 200 from the top and bottom rather than the sides.

FIG. 5 depicts monitor assembly 100 attached to a computing device 200 from the rear. In one embodiment, monitor assembly 100 comprises a monitor 106 and monitor housing 108. The monitor can be, but is not limited to, a flat Liquid Crystal Display (LCD), a plasma display, or the like. The monitor housing 108 contains and protects the monitor 106 when it is not in use. And also contains features to permit the monitor 106 to lock and rotate.

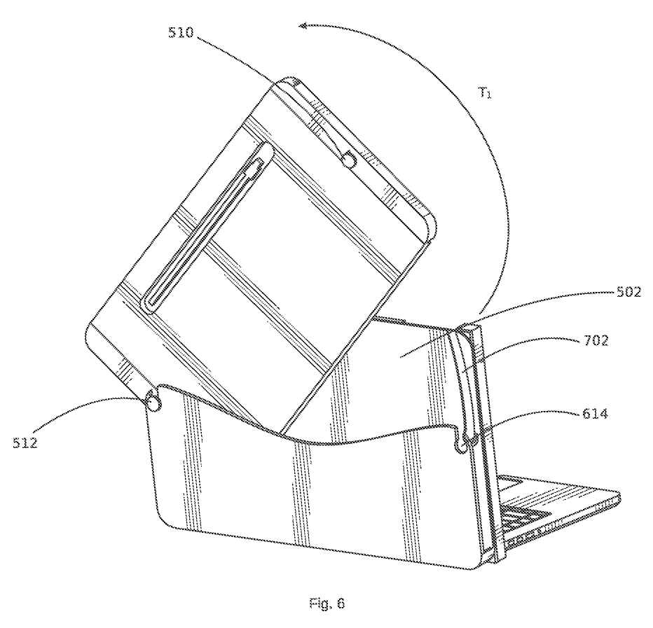

In a preferred embodiment, and in reference to FIG. 5, monitor housing 108 comprises a front retainer 501 and rear retainer 502 (see FIG. 6) positioned substantially planar and parallel to one another such that retainer 501, 502 define a space configured to have the monitor 106 stored therebetween. Each retainer 501, 502 may be coupled by a bottom portion 504 to protect the portable monitor therein and provide a base for the monitor to rest up when in a closed configuration.

In an embodiment, monitor 106 is retained within the housing 108 by first and second monitor attachment mechanism 510, 512. In one embodiment, monitor 106 comprises attachment mechanisms 510, 512 which are mounted along sides of monitor 106 centrally with respect to a top and bottom of the monitor. In one embodiment monitor 106 is configured to pivot to the left or right about an axis of the attachment mechanisms and with respect to housing 108. In one embodiment, the axis is orthogonal to a flat screen of the monitor 106. In one embodiment, first attachment mechanism 510 is positioned within a recess at one side 520 of the housing 108, while a second attachment mechanism 512 is positioned within a recess at a second side 522 of the housing 108. In one embodiment, the recesses are formed within front retainer 501 of the housing 108.

In an embodiment, the monitor assembly 100 may have a support 514 disposed thereon. The support may be hinged at an end allowing the user to articulate the support about the hinge and supportably engage the non hinged end with a surface. The support 514 may allow the user to prop the monitor assembly 100 at an angle to enhance the visual orientation of the monitor 106.

FIG. 5 depicts a monitor in a stored position. In one embodiment, attachment mechanism 510 and 512, can be, but are not limited to, pins, posts, quick release pins, post, magnets, fasteners, or the like. The monitor 106 attachment mechanism 510 and 512 are located in a predetermined orientation from the bottom of the monitor housing 108 to provide for proper rotation of the monitor 106. In a preferred embodiment, attachment mechanisms 510 and 512 are located centrally along each side of the monitor. In the stored position of FIG. 5, attachment mechanism 510 and 512 are both positioned with recesses 612, 614 of housing 108.

In one embodiment, monitor 106 can removed from housing 108 by lifting the monitor vertically up and out of recesses 612, 614. In one embodiment, recesses 612, 614 comprise a curved wall. In one embodiment, recesses 612, 614 comprise a u-shaped recess that defines a smaller channel at its open top than at its closed bottom. In one embodiment, the width of the smaller channel acts as a stopper to larger width attachment mechanisms inserted within the channel.

In an embodiment, attachment mechanisms 510, 512 comprise quick release pins that mate with a corresponding opening within the monitor 106. In one embodiment, attachment mechanisms 510 comprise a diameter that is larger than a width of the open top of the recesses 612, 612 such that with the attachment mechanisms mounted within the recesses, the recesses keep the monitor 106 retained to the housing 108. In one embodiment, attachment mechanisms 510, 512 can be inserted and removed from a corresponding opening in the monitor to effectuate pivotal rotation or removal of the monitor 106. In one embodiment, a user may remove one of both of the attachment mechanisms to effectuate pivotal rotation of the monitor about the other non-removed attachment mechanism or to permit removal of the monitor 106 from the housing 108.

Now referring to FIG. 6, a user has disengaged a first 510 attachment mechanism to permit the monitor 106 to articulate about second attachment mechanism 512 and such that the monitor travels along travel path T₁.

In an embodiment, rear retainer 502 of the housing 108 may comprise a recessed channel 602 along the travel path of each attachment mechanism 510, 512 to accommodate ends of the attachment mechanisms that exit from an opposite side of the monitor 106 after having been inserted into respective holes in the monitor.

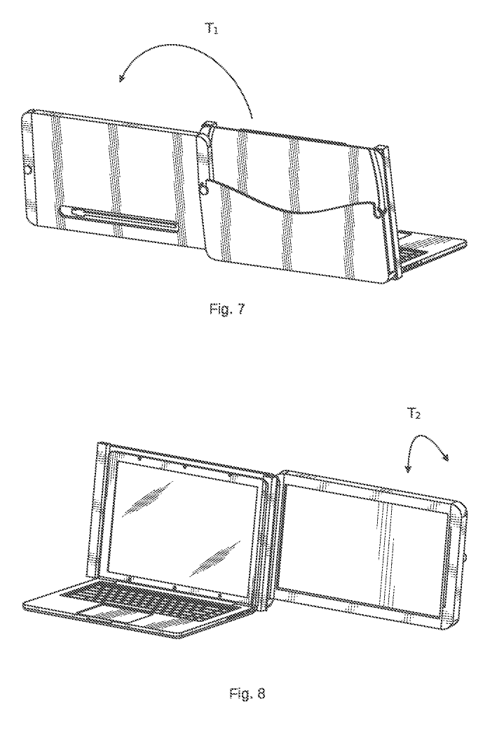

FIG. 7 depicts the monitor assembly 100 in a fully open position, where attachment mechanism 510 has been removed from a corresponding recess in the housing 108 to allow monitor 106 to swivel about attachment mechanism 512. It is identified that monitor 106 can rotate either about 510, 512, so that a user has the option of which side of the computing device 200 monitor 106 extends from.

FIG. 8 depicts the monitor assembly 100 in an extended position from the front of the computing device 200. This shows how the monitor 106 is positioned next to computing device 200 to be able to view both the monitor and the computing device.

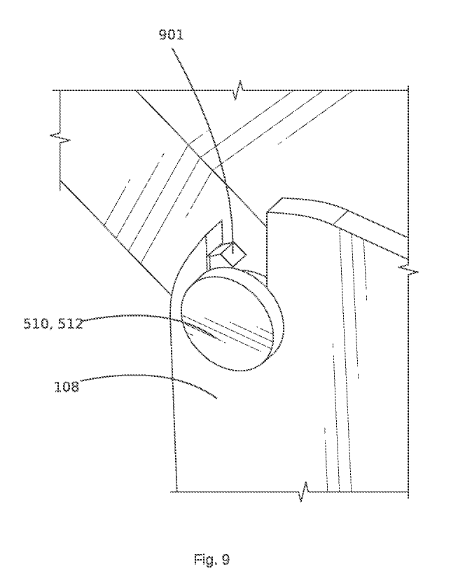

Referring now to FIG. 9, in one embodiment, recesses 610 and 612 may each be formed with a moveable stopper 901. In an embodiment, the stopper 901 is spring loaded and extends from a recess in a manner that blocks attachment mechanism from being removed until the stopper is manually retracted.

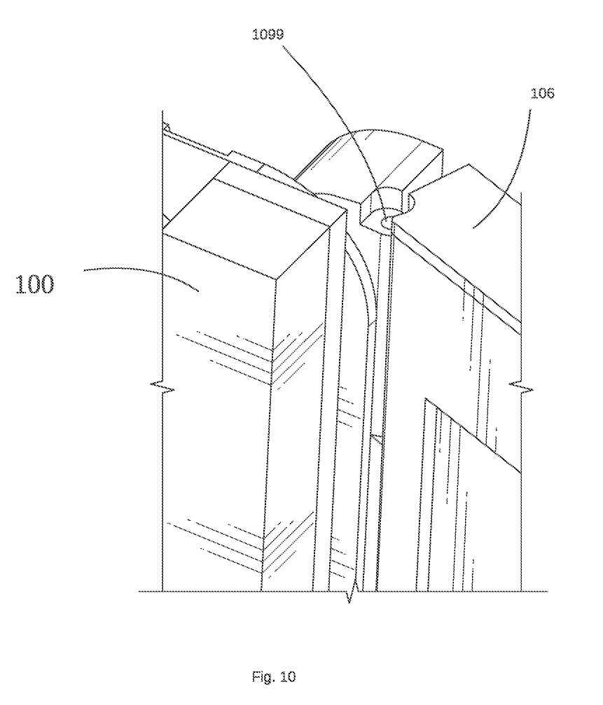

FIG. 10 depicts an embodiment where a side of a monitor 106 is joined to a housing 108 via a vertically disposed hinge 1099 that allows the monitor to articulate with respect to a vertical axis defined by the hinge and in a forward or backward orientation with respect to computing device housing 108 when mounted on a computing device 200, with respect to the computing device.

The monitor 106 is in electrical communication with the computing device 200 via a cable. In an embodiment, the cable can be stored in a recess in housing 108 when not in use, and is connected when the monitor 106 is to be connected to computing device 200. In one embodiment, the cable is a separate from the housing 108. In another embodiment, the cable is an integrated feature of the monitor assembly 100. In the embodiment where the cable is an integrated feature of the monitor assembly 100, there are two cables so that the monitor 106 can be plugged into the computing device 200 regardless of the orientation of the monitor 106. The cable can be, but is not limited to Universal Serial Bus (USB), High-Definition Multimedia Interface (HDMI), Digital Visual Interface (DVI), Video Graphic Array (VGA), and the like. In additional embodiments, the cable is detachable to allow for different types of connection means to computing device 200 and also to reduce clutter when storing or traveling with the monitor assembly 100.

The invention is inclusive of combinations of the embodiments or embodiments described herein. References to “a particular embodiment” or “embodiment” and the like refer to features that are present in at least one embodiment of the invention. Separate references to “an embodiment” or “particular embodiments” or “embodiments” or the like do not necessarily refer to the same embodiment or embodiments; however, such embodiments are not mutually exclusive, unless so indicated or as are readily apparent to one of skill in the art. The use of singular or plural in referring to “method” or “methods” and the like is not limiting. The word “or” is used in this disclosure in a non-exclusive sense, unless otherwise explicitly noted.

This written description uses examples to disclose the invention, including the best mode, and also to enable any person skilled in the art to practice embodiments of the invention, including making and using any devices or systems and performing any incorporated methods. Although an exemplary embodiment of the present invention has been shown and described, it will be apparent to those having ordinary skill in the art that a number of changes, modifications or alterations to the invention described herein may be made, none of which depart from the spirit of the present invention. All such changes, modifications, and alterations should therefore be seen as being within the scope of the present invention.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiment disclosed herein, but instead as being fully commensurate in scope with the spirit of the invention throughout the description.

1. An accessory monitor assembly, comprising:
a frame comprised of a front retainer and a rear retainer, wherein the rear retainer and the front retainer define a space therebetween;
a first arm and a second arm coupled to the frame, wherein the first arm is mounted to a first side of the rear retainer, wherein the second arm is mounted to a second side of the rear retainer, wherein the first arm and second arm are configured to extendingly couple and de-couple the accessory monitor assembly to a portable computer device; and
a monitor comprised of a flat display coupled to the frame, wherein the monitor is configured to be stored in the space via rotation of the monitor into the space about a fixed axis, and wherein the monitor is configured to be removed from the space via rotation of the monitor out of the space about the fixed axis.

2. The accessory monitor assembly of claim 1, wherein the fixed axis comprises two fixed axes, and wherein the monitor comprises two posts, and wherein the two posts are disposed about the two fixed axes.

3. The accessory monitor assembly of claim 2, where the frame comprises two recesses, wherein the two recesses are configured to receive and release the two posts.

4. The accessory monitor assembly of claim 3, wherein the two recesses are each defined by curved walls.

5. The accessory monitor assembly of claim 3, wherein the monitor is configured to be received and released from the frame via linear movement of at least one of the two posts into or from at least one of the two recesses.

6. The accessory monitor assembly of claim 5, wherein the monitor is configured to be received and released from the frame via linear movement of both of the two posts into or from the two recesses.

7. The accessory monitor assembly of claim 3, wherein each recess is comprised of a stopper configured to retain one of the two posts during the rotation of the monitor.

8. The accessory monitor assembly of claim 7, wherein the stopper is spring loaded.

9. The accessory monitor assembly of claim 5, wherein the flat display is configured to be viewable in conjunction with a display of the portable computer device when only one of the two posts is received within one of the two recesses.

10. The accessory monitor assembly of claim 2, wherein the two posts are orthogonal to a surface of the flat display, wherein the monitor comprises two opposite ends and a top and a bottom, and wherein each of the two posts are disposed centrally between the top and bottom along the two opposite ends.

11. The accessory monitor assembly of claim 10, wherein each of the two opposite ends are coupled to the flat display via a mechanism that allows the display to pivot forward or backward with respect to the frame.

12. The accessory monitor assembly of claim 11, wherein the mechanism comprises a hinge.

13. An accessory monitor assembly for use with a portable computer device comprising:
an attachment mechanism configured to releasably attach the assembly to portable computer devices, wherein the attachment mechanism is also configured to de-attach the assembly from the portable computer devices; and
a monitor comprised of a flat display, wherein the monitor is coupled to the attachment mechanism, wherein the monitor is configured to be pivotally rotated either to the left or right with respect to the assembly via a first rotation mechanism and along an axis that is orthogonal with respect to a surface of the flat display.

14. The accessory monitor assembly of claim 13, wherein the monitor comprises two opposite ends and a top and a bottom, wherein the first rotation mechanism is disposed between the top and bottom along and between one of the two opposite ends.

15. The accessory monitor assembly of claim 14, wherein the assembly comprises a second rotation mechanism, wherein the second rotation mechanism is configured to mate with the first rotation mechanism.

16. The accessory monitor assembly of claim 15, wherein the first rotation mechanism comprises a post that is disposed about the axis.

17. The accessory monitor assembly of claim 13, wherein the monitor is configured to be attached to and decoupled from the attachment mechanism via the first rotation mechanism.

18. The accessory monitor assembly of claim 13, wherein the portable computer device is a laptop or notebook computer.

19. A method of attaching an accessory monitor to a portable computer for use with the portable computer, comprising the steps of:
attaching the accessory monitor to a back side of a portable computer having a display;
rotating the accessory monitor either to the left or to the right with respect a center of the display to view the accessory monitor and the display;
rotating the accessory monitor either to the right or to the left with respect to the center of the display to store the accessory monitor; and
removing the accessory monitor from the back side of the portable computer.

20. The method of claim 19, wherein the monitor comprises a flat screen and two opposite ends and a top and a bottom, wherein the step of rotating is performed about an axis that is orthogonal to the flat screen, and wherein the axis is located between the top and bottom along and between the two opposite ends.
